(19) United States
(12) Patent Application Publication
(10) Pub. No.: US 2015/0337160 A1
(43) Pub. Date: Nov. 26, 2015

(54) INSULATING LAYER-FORMING COMPOSITION AND THE USE THEREOF

(71) Applicant: Hilti Aktiengesellschaft, Schaan (LI)

(72) Inventors: Johannes Brinkhorst, Landsberg (DE); Armin Pfeil, Kaufering (DE)

(21) Appl. No.: 14/652,670

(22) PCT Filed: Dec. 11, 2013
(86) PCT No.: PCT/EP2013/076213

§ 371 Date: Jun. 16, 2015

(30) Foreign Application Priority Data
Dec. 18, 2012 (DE) 102012223514.0

(51) Int. Cl. C09D 133/14; C08K 3/22; C08K 3/32; C08K 5/053; C08K 5/3492

(52) U.S. Cl. CPC C09D 133/14; C08K 5/053; C08K 5/34922; C08K 3/32; C08K 3/22; C08K 2003/323; C08K 2003/2241

(57) ABSTRACT

An insulating layer-forming composition, which contains an epoxy thiol-ene based binding agent is provided. The composition, the expansion rate of which is relatively high, enables coatings to be applied in the layer thickness required for the fire-resistance time concerned in a simple and rapid manner, wherein the layer thickness can be reduced to a minimum and a high insulating effect can still be achieved. The composition is especially suitable for fire protection control, more particularly as a coating of metallic and non-metallic substrates, for example steel components such as pillars, supports or frame members, for increasing the fire-resistance time.

The present invention relates to an insulating layer-forming composition, in particular a composition having intumescent properties, which contains a thiol-ene-based binding agent, and to the use thereof for fire protection, in particular for coating components, such as pillars, supports or frame members, for increasing the fire resistance duration.

### BACKGROUND

Insulating layer-forming compositions, also called intumescent compositions, are generally applied to the surface of components for the purpose of forming coatings, in order to protect the components from fires or against extreme heat exposure due, for example, to a fire. Steel structures are now an inherent part of modern architecture, even if they have a distinct disadvantage as compared to reinforced concrete steel construction. Above approximately 500° C., the load-bearing capacity of steel drops by 50%, i.e., the steel loses its stability and its load-bearing capacity. This temperature may already be reached after approximately 5 to 10 minutes, depending on the fire load, for example, in the case of direct exposure to fire (approximately 1,000° C.), which frequently results in a loss of load-bearing capacity of the structure. The goal of fire protection, in particular of steel fire protection in the event of fire, is to prolong as long as possible the time span up to the loss of the load-bearing capacity of a steel structure, in order to save human lives and valuable assets.

For this purpose, the building codes of many countries require corresponding fire resistance times for particular buildings made of steel. They are defined by so-called F-classes, such as F 30, F 60, F 90 (fire resistance classes according to DIN 4102-2) or American classes according to ASTM, etc. F 30, for example, according to DIN 4102-2 means that in the event of fire, a supporting steel structure under standard conditions must be able to withstand the fire for at least 30 minutes. This is normally achieved in that the heating rate of the steel is slowed, for example, by covering the steel structure with insulating layer-forming coatings. This involves painted coats, the components of which expand in the event of fire, while forming a solid microporous carbon foam. Formed in the process is a fine-pored and thick foam layer, the so-called ash crust, which, depending on the composition, is highly heat insulating and thus slows the heating of the component, so that the critical temperature of approximately 500° C. is reached at the earliest after 30, 60, 90, 120 minutes or up to 240 minutes. Essential for the achievable fire resistance is invariably the layer thickness of the coating applied or the ash crust produced by it. Closed profiles, such as pipes, given comparable solidity, require approximately double the amount as compared to open profiles, such as supports having a double-T profile. In order to adhere to the required fire resistance times, the coatings must have a certain thickness and, when exposed to heat, must be capable of forming an advantageously voluminous and therefore well-insulating ash crust, which remains mechanically stable for the duration of the fire load.

There exist various systems in the prior art for such purpose. Essentially, a distinction is drawn between 100% systems and solvent-based or water-based systems. In solvent-based systems or water-based systems, binding agents, usually resins, are applied as a solution, dispersion or emulsion to the components. These may be implemented as single component systems or multi-component systems. The solvent or water, once it is applied, evaporates and leaves behind a film which dries over time. A further distinction may be drawn in this case between systems, in which the coating essentially no longer changes during drying, and systems in which, after evaporation, the binding agent cures primarily as the result of oxidation reactions and polymerization reactions, which are induced, for example, by the oxygen from the atmosphere. The 100% systems contain the components of the binding agent without a solvent or water. They are applied to the component, the “drying” of the coating taking place merely by reacting the binding agent components with one another.

The solvent-based systems or water-based systems have the disadvantage that the drying times, also called curing times, are long and, moreover, multiple layers must be applied, i.e., require multiple work steps, in order to achieve the required layer thickness. Since each individual layer must be correspondingly dried prior to application of the next layer, the result is more hours of labor and correspondingly high costs on the one hand, and a delay in the completion of the building structure, since in part several days pass, depending on the climatic conditions, before the required layer thickness is applied. Also disadvantageous is the fact that because of the required layer thickness, the coating may tend to form cracks and to peel during drying or when exposed to heat, as a result of which, in the worst case, the subsurface is partially exposed, in particular in systems in which the binding agent does not re-harden after the solvent or the water evaporates.

In order to overcome this disadvantage, epoxy-amine-based two-component systems or multi-component systems have been developed, which involve almost no solvents, so that a curing occurs significantly more rapidly and, in addition, thicker layers may be applied in one work step, so that the required layer thickness is built up significantly more rapidly. However, these systems have the disadvantage that the binding agent forms a very stable and rigid polymer matrix, often with a high softening range, which inhibits the formation of foam by the foaming agent. For this reason, thick layers must be applied in order to produce a sufficient foam thickness for the insulation. This, in turn, is disadvantageous, since it requires a large amount of material. To be able to apply these systems, processing temperatures of up to +70° C. are frequently required, which makes the application of such systems labor-intensive and their installation costly. Moreover, some of the binding agent components used are toxic or otherwise problematic (for example, irritating, caustic), such as, for example, the amines or amine mixtures used in the epoxy-amine systems.

In the area of decorative and protective coatings, the Michael addition is known as a hardening mechanism. The reaction in this case is normally catalyzed using strong bases, such as, for example, primary or secondary amines. In the case of polymer-based formulations, which have hydrolytically cleavable bonds, such as polyesters, the disadvantage that arises, however, is that the coatings have a reduced resistance to hydrolysis. The publication WO 2010/030771 A1, for example, describes a method for applying a curable composition to a substrate, the hardening taking place on polyenes in the presence of a phosphine catalyst by a Michael addition of a compound containing active hydrogen atoms. The Michael addition is also known in the area of adhesives as a hardening mechanism, as is described, for example, in EP 1462501 A1.

### SUMMARY OF THE INVENTION

A fire protection coating on this basis, which contains fire protection additives, is not known, however. It is also not known up to what ratio of the fire protection additive it may contain.

It is an object of the present invention to provide an insulating layer-forming coating system of the aforementioned kind, which avoids the aforementioned disadvantages, which is, in particular not solvent-based or water-based and exhibits a rapid curing, is simple to apply due to properly matched viscosity, and requires only a small layer thickness due to the high intumescence, i.e., the formation of an effective ash crust layer.

The present invention provides an insulating layer-forming composition, including a component A containing a multifunctional Michael acceptor, which includes at least two electron-deficient carbon multiple bonds per molecule, including a component B containing a multifunctional Michael donor, which includes at least two thiol groups (thiol-functionalized compound), and including a component C containing an insulating layer-forming additive.

With the composition according to the present invention, it is possible to apply coatings having the required layer thickness for the respective fire resistance duration in a simple and rapid manner. The advantages achieved by the present invention are essentially that the slow curing times inherent to the solvent-based or water-based systems could be shortened significantly, which reduces the working time considerably. Unlike the epoxy-amine systems, an application without heating the composition, for example, via the widely used airless spray method, is possible due to the low viscosity of the composition in the area of application, adjusted using suitable thickener systems.

An additional advantage is that compounds hazardous to health and subject to labeling such as, for example, critical amine compounds, may be largely or completely dispensed with.

Due to the lower softening range of the polymer matrix as compared to the epoxy-amine-based systems, the intumescence is relatively high in terms of the expansion rate, so that a strong insulating effect is achieved even with thin layers. Contributing to this is also the potential high degree of filling of the composition with fire protection additives. Material expenditure drops accordingly, which has a favorable impact on material costs, in particular in the case of large-area application. This is achieved, in particular by using a reactive system, which does not physically dry and thus sustains no loss of volume as a result of the drying of solvents or of water in the case of water-based systems, but rather hardens nucleophilically. A solvent content of approximately 25% is therefore typical in a classical system. This means that of a 10-mm layer, only 7.5 mm remains as the actual protective layer on the substrate to be protected. In the composition according to the present invention, more than 96% of the coating remains on the substrate to be protected. In addition, the relative ash crust stability is very high due to the structure of the foam formed in the event of fire.

Compared to solvent-based systems or water-based systems when applied without an undercoating, the compositions according to the present invention exhibit excellent adhesion to different metallic and non-metallic substrates, as well as excellent cohesion and impact resistance.

For a better understanding of the present invention, the following explanations of the terminology used herein are considered useful. As provided in the present invention:

a “Michael addition” is in general a reaction between a Michael donor and a Michael acceptor, frequently in the presence of a catalyst such as, for example, a strong base, a catalyst not being absolutely necessary; the Michael addition is sufficiently known and frequently described in the literature.

a “Michael acceptor” is a compound having at least one functional Michael acceptor group, which contains a Michael-active carbon multiple bond, such as a C—C double bond or a C—C triple bond, which is non-aromatic, which is electron-deficient; a compound having two or multiple Michael-active carbon multiple bonds is referred to as a multifunctional Michael acceptor; a Michael acceptor may include one, two, three or more separate functional Michael acceptor groups; each functional Michael acceptor group may include a Michael-active carbon multiple bond; the total number of Michael-active carbon multiple bonds on the molecule is the functionality of the Michael acceptor; as used herein, the “skeleton” of the Michael acceptor is the other part of the acceptor molecule to which the functional Michael acceptor group may be attached;

“electron-deficient” means that the carbon multiple bond carries electron-withdrawing groups in the immediate vicinity, i.e., generally on the carbon atom adjacent to the multiple bond, which groups withdraw electron density from the multiple bond, such as C═O and/or C═N;

a “Michael donor” is a compound having at least one functional Michael donor group, which is a functional group containing at least one Michael-active hydrogen atom, which is a hydrogen atom deposited on a heteroatom, such as thiols; a compound having two or multiple Michael-active hydrogen atoms is referred to as a multifunctional Michael donor; a Michael donor may include one, two, three or more separate functional Michael donor groups; each functional Michael donor group may include a Michael-active hydrogen atom; the total number of Michael-active hydrogen atoms on the molecule is the functionality of the Michael donor; as used herein, the “skeleton” of the Michael donor is the other part of the donor molecule, to which the functional Michael donor group is attached; this definition also includes anions of the Michael donors;

“chemical intumescence” means the formation of a voluminous, insulating ash layer by compounds matched to one another, which react with one another when exposed to heat;

“physical intumescence” means the formation of a voluminous, insulating layer through the expansion of a compound, which releases gas when exposed to heat, without a chemical reaction taking place between the two compounds, as a result of which the volume of the compound increases by a multiple of the original volume;

“insulating layer-forming” means that in the event of fire, a solid microporous carbon foam forms, so that, depending on the composition, the formed, fine-pored and thick foam layer, the so-called ash crust, insulates a substrate from heat.

“carbon source” is an organic compound which, as a result of incomplete combustion, leaves behind a carbon skeleton and does not fully combust to form carbon dioxide and water (carbonification); these compounds are also referred to as “carbon skeleton formers”;

an “acidifier” is a compound which forms a non-volatile acid when exposed to heat, i.e., above approximately 150° C., for example, through decomposition, and as a result acts as a catalyst for the carbonification; in addition, it may assist in lowering the viscosity of the melt of the binding agent; the term “dehydrogenation catalyst” is used synonymously in this regard.

a “propellant” is a compound which decomposes at increased temperatures while forming inert, i.e., non-combustible gases, and expands the carbon skeleton formed by carbonification and, possibly, the softened binding agent to form a foam (intumescence); this term is used synonymously with “gas former”;

an “ash crust stabilizer” is a so-called skeleton-forming compound, which stabilizes the carbon skeleton (ash crust) formed from the interaction of the carbon formation from the carbon source and the gas from the propellant, or from the physical intumescence. The principle mechanism in this case is that the carbon layers, forming very softly per se, are mechanically solidified by inorganic compounds. The addition of such an ash crust stabilizer contributes to an essential stabilization of the intumescent crust in the event of fire, since these additives enhance the mechanical strength of the intumescent layer and/or prevent it from draining off.

“(meth)acryl . . . / . . . (meth)acryl . . . ” means that both the “methacryl . . . / . . . methacryl . . . ”- and the “acryl . . . / . . . acryl . . . ” compounds are to be included;

an “oligomer” is a molecule having 2 to 5 repetition units, and a “polymer” is a molecule having 6 or more repetition units and may include structures which are linear, branched, stellate, wound, hyper-branched or cross-linked; polymers may include a single type of repetition unit (“homopolymers”) or they may include more than one type of repetition unit (“copolymers”). As used herein, “resin” is synonymous with polymer.

In general, it is assumed that reacting a Michael donor having a functionality of two with a Michael acceptor having a functionality of two will produce linear molecular structures. Frequently, it is necessary to produce molecular structures which are branched and/or cross-linked, which requires the use of at least one constituent having a functionality of greater than two. For this reason, the multifunctional Michael donor or the multifunctional Michael acceptor, or both, preferably have a functionality of greater than two.

According to the present invention, any compound that has at least two functional groups constituting Michael acceptors may be used as a multifunctional Michael acceptor. Each functional group (Michael acceptor) in this case is attached to a skeleton either directly or via a linker.

According to the present invention, any compound that has at least two thiol groups as functional Michael donor groups, which may add to the electron-deficient double bonds in a Michael addition reaction (thiol-functionalized compound), may be used as a Michael donor. In such case, each thiol group is attached to a skeleton either directly or via a linker.

The multifunctional Michael acceptor or the multifunctional Michael donor of the present invention may have any of a wide variety of skeletons, whereby these may be identical or may differ.

According to the present invention, the skeleton is a monomer, an oligomer or a polymer.

In some specific embodiments of the present invention, the skeletons include monomers, oligomers or polymers having a molecular weight (Mw) of 50,000 g/mol or less, preferably 25,000 g/mol or less, more preferably 10,000 g/mol or less, even more preferably 5,000 g/mol or less, even more preferably 2,000 g/mol or less, and most preferably 1,000 g/mol or less.

Alkanediols, alkylene glycols, sugar, polyvalent derivatives thereof or mixtures thereof and amines, such as ethylene diamine and hexamethylene diamine, and thiols, for example, may be mentioned as monomers suitable as skeletons. The following may be mentioned by way of example as oligomers or polymers suitable as skeletons: polyalkylene oxide, polyurethane, polyethylene vinyl acetate, polyvinyl alcohol, polydiene, hydrogenated polydiene, alkyde, alkyde polyester, (meth)acryl polymer, polyolefine, polyester, halogenated polyolefine, halogenated polyester, polymercaptane, as well as copolymers or mixtures thereof.

In preferred specific embodiments of the present invention, the skeleton is a polyvalent alcohol or a polyvalent amine, whereby these may be monomers, oligomers or polymers. The skeleton is more preferably a polyvalent alcohol.

The following may be mentioned by way of example as polyvalent alcohols suitable as skeletons: alkanediols, such as butanediol, pentanediol, hexanediol, alkylene glycols, such as ethylene glycol, propylene glycol and polypropylene glycol, glycerin, 2-(hydroxyl methyl)propane-1,3-diol, 1,1,1,-tris(hydroxymethyl)ethane, 1,1,1-trimethylolpropane, di(trimethylolpropane), tricyclodecane dimethylol, 2,2,4-trimethyl-1,3-pentanediol, bisphenol A, cyclohexane dimethanol, alkoxylated and/or ethoxylated and/or propoxylated derivatives of neopentyl glycol, tertraethylene glycol cyclohexanedimethanol, hexanediol, 2-(hydroxymethyl)propane-1,3-diol, 1,1,1-tris(hydroxymethyl)ethane, 1,1,1-trimethylolpropane and castor oil, pentaerythritol, sugar, polyvalent derivatives thereof or mixtures thereof.

Any units suitable for binding skeleton and functional groups may be used as linkers. For thiol-functionalized compounds, the linker is preferably selected from among the structures (I) through (XI). For Michael acceptors, the linker is preferably selected from among the structures (XII) through (XIX),

1: Bond for functional group

2: Bond for skeleton

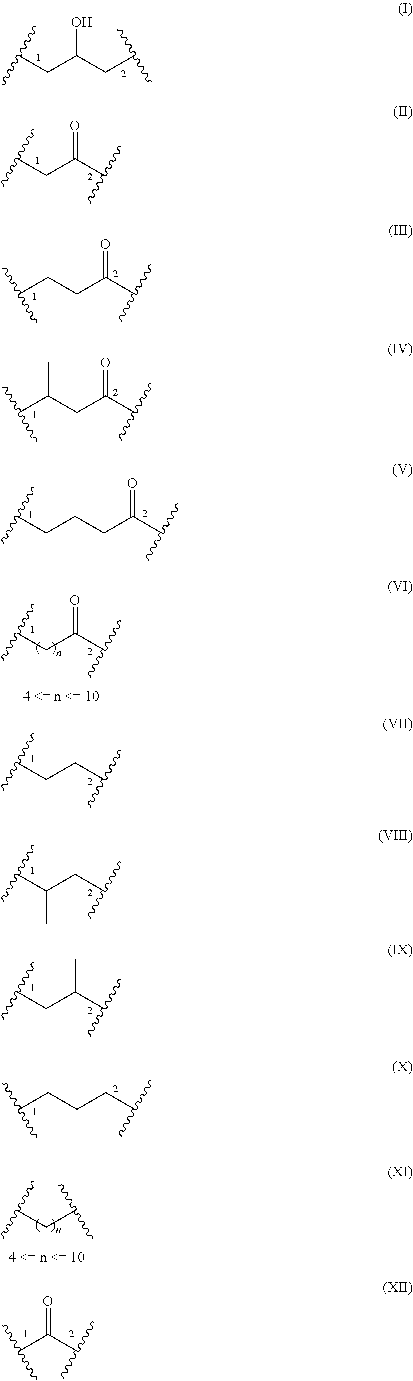

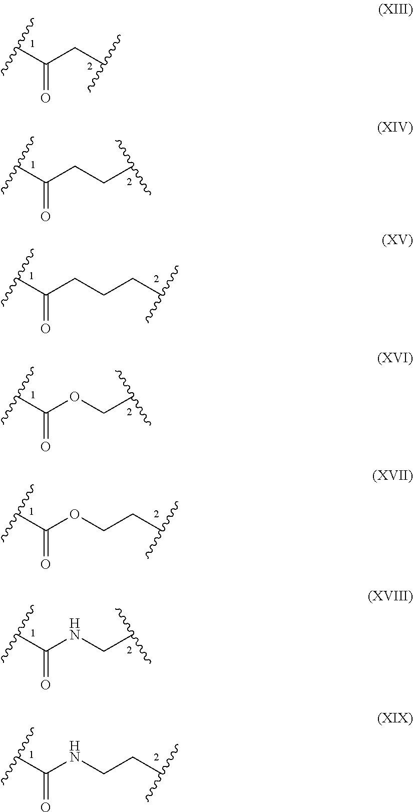

The structures (I), (II), (III) and (IV) are particularly preferred as linkers for thiol-functionalized compounds. Structure (XII) is particularly preferred as a linker for Michael acceptors.

The thiol group (—SH) is the functional group for thiol-functionalized compounds.

Particularly preferred thiol-functionalized compounds are esters of α-thioacetic acid (2-mercaptoacetate), β-thiopropionic acid (3-mercaptopropionate) and 3-thiobutryic acid (3-mercaptobutyrate) having monoalcohols, diols, triols, tetraols, pentaols or other polyols, such as 2-hydroxy-3-mercaptopropyl derivatives of monoalcohols, diols, triols, tetraols, pentaols or other polyols. Mixtures of alcohols may also be used as a basis for the thiol-functionalized compound. In this respect, reference is made to the WO 99/51663 A1 publication, the contents of which are incorporated by reference in this application.

Particularly suitable examples of thiol-functionalized compounds which may be mentioned are: glycol-bis(2-mercaptoacetate), glycol-bis(3-mercaptopropionate), 1,2-propylene glycol-bis(2-mercaptoacetate), 1,2-propylene glycol-bis(3-mercaptopropionate), 1,3-propylene glycol-bis(2-mercaptoacetate), 1,3-propylene glycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylolpropane-tris(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptobutyrate), Capcure 3-800 (BASF), GPM-800 (Gabriel Performance Products), Capcure LOF (BASF), GPM-800LO (Gabriel Performance Products), KarenzMT PE-1 (Showa Denko), 2-ethylhexylthioglycolate, iso-octylthioglycolate, di(n-butyl)thiodiglycolate, glycol-di-3-mercaptopropionate, 1,6-hexanedithiol, ethylene glycol-bis(2-mercaptoacetate) and tetra(ethylene glycol)dithiol.

The thiol-functionalized compound may be used alone or as a mixture of two or multiple different thiol-functionalized compounds.

Any group that forms a Michael acceptor in combination with the one linker is suitable as a functional group for Michael acceptors. A compound having at least two electron-deficient carbon multiple bonds, such as C—C double bonds or C—C-triple bonds, preferably C—C-double bonds, per molecule is advantageously used for a Michael acceptor as a functional Michael acceptor group.

According to one preferred specific embodiment of the present invention, the functional group of the Michael acceptor is a compound having the structure (XX):

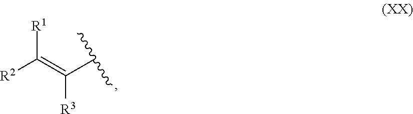

in which R₁, R₂ and R₃ represent, each independently of one another, hydrogen or organic residues, such as a linear, branched or cyclical, possibly, substituted alkyl group, aryl group, aralkyl group (also called aryl-substituted alkyl group) or alkaryl group (also called alkyl-substituted aryl group), including derivatives and substituted versions thereof, whereby these may also contain, independently of one another, additional ether groups, carboxyl groups, carbonyl groups, thiol-analog groups, nitrogen-containing groups or combinations thereof.

Some suitable multifunctional Michael acceptors in the present invention include, for example, molecules in which some or all of the structures (XX) are residues of (meth)acrylic acid, fumaric acid or maleic acid, substituted versions or combinations thereof, which are attached via an ester bond to the multifunctional Michael acceptor molecular. One compound having structures (XX), which include two or more residues of (meth)acrylic acid, is referred to herein as “polyfunctional (meth)acrylate”. Polyfunctional (meth)acrylates having at least two double bonds, which may act as the acceptor in the Michael addition, are preferred.

Examples of suitable di(meth)acrylates include, but are not limited to: ethylene glycol-di(meth)acrylate, propylene glycol-di(meth)acrylate, diethylene glycol-di(meth)acrylate, dipropylene glycol-di(meth)acrylate, triethylene glycol-di(meth)acrylate, tripropylene glycol-di(meth)acrylate, tertraethylene glycol-di(meth)acrylate, tetrapropylene glycol-di(meth)acrylate, polyethylene glycol-di(meth)acrylate, polypropylene glycol-di(meth)acrylate, ethoxylated bisphenol A-di(meth)acrylate, bisphenol A diglycidylether-di(meth)acrylate, resorcinol diglycidylether-di(meth)acrylate, 1,3-propanediol-di(meth)acrylate, 1,4-butanediol-di(meth)acrylate, 1,5-pentanediol-di(meth)acrylate, 1,6-hexanediol-di(meth)acrylate, neopentylglycol-di(meth)acrylate, cyclohexanedimethanol-di(meth)acrylate, ethoxylated neopentyl glycol-di(meth)acrylate, propoxylated neopentyl glycol-di(meth)acrylate, ethoxylated cyclohexane dimethanol-di(meth)acrylate, propoxylated cyclohexane dimethanol-di(meth)acrylate, arylurethane-di(meth)acrylate, aliphatic urethane-di(meth)acrylate, polyester-di(meth)acrylate and mixtures thereof.

Examples of suitable tri(meth)acrylates include, but are not limited to: trimethylolpropane-tri(meth)acrylate, trifunctional (meth)acrylic acid-s-triazine, glycerol-tri(meth)acrylate, ethoxylated trimethylolpropane-tri(meth)acrylate, propoxylated trimethylolpropane-tri(meth)acrylate, tris(2-hydroxyethyl)isocyanurate-tri(meth)acrylate, ethoxylated glycerol-tri(meth)acrylate, propoxylated glycerol-tri(meth)acrylate, pentaerythritol-tri(meth)acrylate, arylurethane-tri(meth)acrylate, aliphatic urethane-tri(meth)acrylate, melamine-tri(meth)acrylate, epoxy-novolac-tri(meth)acrylate, aliphatic epoxy-tri(meth)acrylate, polyester-tri(meth)acrylate and mixtures thereof.

Examples of suitable tetra(meth)acrylates include, but are not limited to: di(trimethylolpropane)-tetra(meth)acrylate, pentaerythritol-tetra(meth)acrylate, ethoxylated pentaerythritol-tetra(meth)acrylate, propoxylated pentaerythritol-tetra(meth)acrylate, dipentaerythritol-tetra(meth)acrylate, ethoxylated dipentaerythritol-tetra(meth)acrylate, propoxylated dipentaerythritol-tetra(meth)acrylate, arylurethane-tetra(meth)acrylate, aliphatic urethane-tetra(meth)acrylate, melamine-tetra(meth)acrylate, epoxy-novolac-tetra(meth)acrylate, polyester-tetra(meth)acrylate and mixtures thereof.

Mixtures of multifunctional (meth)acrylates may also be used in combination.

Also suitable as the multifunctional Michael acceptor are polyfunctional (meth)acrylates, in which the skeleton is polymeric. The (meth)acrylate groups may be deposited on the polymeric skeleton in a variety of ways. For example, a (meth)acrylate ester monomer may be deposited on a polymerizable functional group through the ester bond, and this polymerizable functional group may be polymerized with other monomers, in such a way that they leave the double bond of the (meth)acrylate group intact.

In another example, a polymer may be provided with functional groups (such as a polyester having residual hydroxyl groups), which may be reacted with a (meth)acrylate ester (for example by transesterification), in order to obtain a polymer having (meth)acrylate side groups in this way. In still another example, a homopolymer or copolymer, which includes a polyfunctional (meth)acrylate monomer (such as trimethylol propane triacrylate), may be produced in such a way that not all acrylate groups react.

In a particularly preferred specific embodiment of the present invention, the functional Michael acceptor group is a (meth)acrylic acid ester of the previously mentioned polyol compounds. Alternatively, Michael acceptors may also be used, in which the structure (XX) is bound to the polyol skeleton via a nitrogen atom instead of an oxygen atom, such as, for example, (meth)acrylamide.

Mixtures of suitable multifunctional Michael acceptors are also suited, such as the acrylamides, nitriles, fumaric acid esters, and maleimides known to those skilled in the art.

Depending on the functionality of the Michael acceptor and/or of the Michael donor, the degree of cross-linking of the binding agent and, thus, both the strength of the resultant coating as well as the elastic properties thereof may be adjusted. At the same time, this has a direct influence on the expansion of the resultant ash crust achievable in the event of fire.

In the composition of the present invention, the relative ratio of multifunctional Michael acceptors to multifunctional Michael donors may be characterized by the reactive equivalent ratio, which is the ratio of the number of all functional groups (XX) in the composition to the number of Michael-active hydrogen atoms in the composition. In some specific embodiments, the reactive equivalent ratio is 0.1 to 10:1; preferably 0.2 to 5:1, more preferably 0.3 to 3:1; even more preferably 0.5 to 2:1; most preferably 0.75 to 1.25:1.

Although the Michael addition reaction already occurs without a catalyst and a hardening takes place, it is possible to use a catalyst for the reaction between the Michael acceptor and the Michael donor.

The catalysts used may be the nucleophiles normally used for Michael addition reactions, in particular between electron-deficient C—C multiple bonds, particularly preferably C—C double bonds, and active hydrogen atom-containing compounds, in particular thiols, such as triaklyphosphines, tertiary amines, of a guanidine base, an alcoholate, a tetraorganoammonium hydroxide, an inorganic carbonate or bicarbonate, a carbonic acid salt or a super base, a nucleophile, such as, for example, a primary or a secondary amine or a tertiary phosphine (cf. for example, C. E. Hoyle, A. B. Lowe, C. N. Bowman, Chem Soc. Rev. 2010, 39, 1355-1387), which are known to those skilled in the art.

Suitable catalysts are, for example, triethylamine, ethyl-N,N-diisopropylamine, 1,4-diazabicyclo[2.2.2]octane (DABCO), 1,8-diazabicyclo[5.4.0]undec-7-en (DBU), 1,5-diazabicyclo[4.3.0]non-5-en (DBN), dimethylaminopyridine (DMAP), tetramethylguanidine (TMG), 1,8-bis(dimethylamino)naphthalene, 2,6-di-tert-butylpyridine, 2,6-lutidine, sodium methanolate, potassium methanolate, sodium ethanolat, potassium ethanolat, potassium-tert-butylalcoholate, benzyltrimethyl ammonium hydroxide, potassium carbonate, potassium bicarbonate, sodium salts or potassium salts of carbonic acids, the conjugated acidities thereof lying between pKa 3 and 11, n-hexylamine, di-n-propylamine, tri-n-octylphosphine, dimethylphenylphosphine, methyldiphenylphosphine and triphenylphosphine.

The catalyst may be used in catalytic quantities or equimolar or in excess.

The viscosity of the composition may be adjusted or adapted according to the application properties by adding at least one reactive diluent.

In one specific embodiment of the present invention, the composition therefore contains additional low-viscosity compounds as reactive diluents, in order to adjust the viscosity of the composition, if necessary. The reactive diluents used may be low-viscosity compounds, as a pure substance or in a mixture, which react with the components of the composition. Examples are allylether, allylester, vinylether, vinylester, (meth)acrylic acid ester and thiol-functionalized compounds. Reactive diluents are preferably selected from the group consisting of allylethers, such as allylethylether, allylpropylether, allylbutylether, allylphenylether, allylbenzylether, trimethylolpropane allylether, allylesters, such as acetic acid allylester, butyric acid allylester, maleic acid diallyl ester, allylacetoacetate, vinylethers, such as butylvinylether, 1,4-butane diolvinylether, tert-butylvinylether, 2-ethylhexylvinylether, cyclohexylvinylether, 1,4-cyclohexane dimethanolvinylether, ethylene glycolvinylether, diethylene glycolvinylether, ethylvinylether, isobutylvinylether, propylvinylether, ethyl-1-propenylether, dodecylvinylether, hydroxypropyl(meth)acrylate, 1,2-ethanedioldi(meth)acrylate, 1,3-propane dioldi(meth)acrylate, 1,2-butane dioldi(meth)acrylate, 1,4-butane dioldi(meth)acrylate, trimethylolpropane tri(meth)acrylate, phenethyl(meth)acrylate, tetrahydrofurfuryl(meth)acrylate, ethyltriglycol(meth)acrylate, N,N-dimethylaminoethyl(meth)acrylate, N,N-dimethylaminomethyl(meth)acrylate, acetoacetoxyethyl(meth)acrylate, isobornyl(meth)acrylate, 2-ethylhexyl(meth)acrylate, diethylene glycoldi(meth)acrylate, methoxypolyethylene glycolmono(meth)acrylate, trimethylcycohexyl(meth)acrylate, 2-hydroxyethyl(meth)acrylate, dicyclopentenyloxyethyl(meth)acrylate and/or tricyclopentadienyldi(meth)acrylate, bisphenol-A-(meth)acrylate, novolakepoxidi(meth)acrylate, di-[(meth)acryloyl-maleoyl]-tricyclo-5.2.1.0.²⁻⁶-decane, dicyclopentenyloxyethylcrotonate, 3-(meth)acryloyl-oxymethyl-tricylo-5.2.1.0.²⁻⁶-decane, 3-(meth)cyclopentadienyl(meth)acrylate, isobornyl(meth)acrylate and decalyl-2-(meth)acrylate.

In principle, other conventional compounds having reactive double bonds may be used, alone or in a mixture, with the (meth)acrylic acid esters, for example, styrene, α-methylstyrene, alkylated styrenes, such as tert-butylstyrene, divinylbenzene and allyl compounds.

According to the present invention, the component C contains an insulating layer-forming additive, the additive possibly including both individual compounds as well as a mixture of multiple compounds.

Insulating layer forming additives used are advantageously of the kind which, when exposed to heat, act by forming an expanded, insulating layer from a flame-retardant material, which protects the substrate from overheating, and thus prevents or at least slows the change of the components bearing the mechanical and static properties caused by exposure to heat. The formation of a voluminous, insulating layer, namely, an ash layer, may be formed by the chemical reaction of a mixture of compounds appropriately matched to one another, which react with one another when exposed to heat. Such systems are known to those skilled in the art by the term chemical intumescence, and may be used in accordance with the present invention. Alternatively, the voluminous, insulating layer may be formed by expansion of a single compound, which releases gases when exposed to heat, without a chemical reaction between two compounds having taken place. Such systems are known to those skilled in the art by the term physical intumescence, and may also be used in accordance with the present invention. Both systems may each be used in accordance with the invention alone or together as a combination.

To form an intumescent layer by chemical intumescence, at least three components are generally required: a carbon source, a dehydrogenation catalyst and a propellant, which are contained, for example, in coatings in a binding agent. When exposed to heat, the binding agent softens and the fire protection additives are released, so that they are able to react with one another in the case of chemical intumescence, or are able to expand in the case of physical intumescence. The acid, which is formed by thermal decomposition from the dehydrogenation catalyst, serves as a catalyst for the carbonification of the carbon source. At the same time, the propellant thermally decomposes while forming inert gases, which causes an expansion of the carbonized (burnt) material and, optionally, the softened binding agent, while forming a voluminous insulating foam.

In one specific embodiment of the present invention, in which the insulating layer is formed by chemical intumescence, the insulating layer-forming additive includes at least one carbon skeleton former, if the binding agent cannot be used as such, at least one acidifier, at least one propellant, and at least one inorganic skeleton former. The components of the additive are selected, in particular so that they are able to develop a synergy, some of the compounds being able to perform multiple functions.

The carbon sources under consideration are the compounds generally used in intumescent fire protection formulations and known to those skilled in the art, such as starch-like compounds, for example, starch and modified starch and/or polyvalent alcohols (polyols), such as saccharides and polysaccharides and/or a thermoplastic or duroplastic polymeric resin binder, such as a phenolic resin, a urea resin, a polyurethane, polyvinylchloride, poly(meth)acrylate, polyvinylacetate, polyvinylalcohol, a silicone resin and/or a rubber. Suitable polyols are polyols from the group sugar, pentaerythritol, dipentaerythritol, tripentaerythritol, polyvinylacetate, polyvinylalcohol, sorbitol, polyoxyethylene-/polyoxypropylene-(EO-PO-) polyols. Pentaerythritol, dipentaerythritol or polyvinylacetate are preferably used.

It is noted that in the event of fire, the binding agent itself may also have the function of a carbon source.

The dehydrogenation catalysts and acidifiers under consideration are the compounds normally used in intumescent fire protection formulations and known to those skilled in the art, such as a salt or an ester of an inorganic, non-volatile acid, selected from among sulfuric acid, phosphoric acid or boric acid. Primarily, phosphorous compounds are used, which have a very wide range, since they extend over multiple oxidation stages of the phosphorous, such as phosphines, phosphine oxides, phosphonium compounds, phosphates, elementary red phosphorous, phosphites and phosphates. The following phosphoric acid compounds may be mentioned by way of example: monoammonium phosphate, diammonium phosphate, ammonium phosphate, ammonium polyphosphate, melamine phosphate, melamine resin phosphates, potassium phosphate, polyol phosphates such as, for example, pentaerythritol phosphate, glycerin phosphate, sorbitol phosphate, mannitol phosphate, dulcitol phosphate, neopentylglycol phosphate, ethylene glycol phosphate, dipentaerythritol phosphate and the like. The phosphoric acid compound used is preferably a polyphosphate or an ammonium polyphosphate. Melamine resin phosphates in this case are understood to mean compounds, such as reaction products of lamelite C (melamine-formaldehyde-resin) having phosphoric acid. Sulfuric acid compounds to be mentioned, by way of example, are: ammonium sulfate, ammonium sulfamate, nitroaniline bisulfate, 4-nitroaniline-2-sulfonic acid and 4,4-dinitrosulfanilamide and the like. Melamine borate, for example, may be mentioned as a boric acid compound.

The propellants under consideration are the compounds normally used in fire protection formulations and known to those skilled in the art, such as cyanuric acid or isocyanuric acid and derivatives thereof, melamine and derivatives thereof. These are cyanamide, dicyanamide, dicyandiamide, guanidine and salts thereof, biguanide, melamine cyanurate, cyanic acid salts, cyanic acid esters and -amides, hexamethoxymethyl melamine, dimelamine pyrophosphate, melamine polyphosphate, melamine phosphate. Hexamethoxymethyl melamine or melamine (cyanuric acid amide) is preferably used.

Also suitable are components which do not limit their mode of action to one single function, such as melamine polyphosphate, which acts both as an acidifier as well as a propellant. Additional examples are described in GB 2 007 689 A1, EP 139 401 A1 and U.S. Pat. No. 3,969,291 A1.

In one specific embodiment of the present invention, in which the insulating layer is formed by physical intumescence, the insulating layer-forming additive includes at least one thermally expandable compound, such as a graphite intercalation compound, which is also known as expandable graphite. These may also be incorporated in the binding agent.

Under consideration as the expandable graphite are, for example, known intercalation compounds of SOₓ, NOₓ, halogen and/or strong acids in graphite. These are also referred to as graphite salts. Expandable graphites, which emit SO₂, SO₃, NO and/or NO₂ at temperatures of, for example, 120 to 350° during expansion, are preferred. The expandable graphite may be present, for example, in the form of platelets having a maximum diameter in the range of 0.1 to 5 mm. This diameter lies preferably in the range of 0.5 to 3 mm. Expandable graphites suitable for the present invention are commercially available. In general, the expandable graphite particles are distributed uniformly in the fire protection elements according to the present invention. However, the concentration of the expandable graphite particles may also vary, e.g., in point, pattern, sheet and/or sandwich form. Reference is made in this regard to EP 1489136 A1, the content of which is incorporated by reference in this application.

At least one ash crust stabilizer is preferably added to the above listed components, since the ash crust formed in the event of fire is generally unstable and, depending on the thickness and structure thereof, may be dispersed by air currents, for example, which adversely impacts the insulating effect of the coating.

The ash crust stabilizers or skeleton formers under consideration are the compounds normally used in fire protection formulations and known to those skilled in the art, for example, expandable graphite and particulate metals, such as aluminum, magnesium, iron and zinc. The particulate metal may be present in the form of a powder, of platelets, flakes, fibers, threads and/or whiskers, the particulate metal in the form of powder, platelets or flakes having a particle size of ≦50 μm, preferably of 0.5 to 10 μm. When using the particulate metal in the form of fibers, threads and/or whiskers, a thickness of 0.5 to 10 μm and a length of 10 to 50 μm are preferred. Alternatively or in addition, an oxide or a compound of a metal of the group including aluminum, magnesium, iron or zinc may be used as an ash crust stabilizer, in particular iron oxide, preferably iron trioxide, titanium dioxide, a borate, such as zinc borate and/or a glass frit made of low melting glasses having a melting temperature preferably at or above 400° C., phosphate or sulphate glasses, melamine polyzinc sulfates, ferro glasses or calcium borosilicates. The addition of such an ash crust stabilizer contributes to a significant stabilization of the ash crust in the event of fire, since these additives increase the mechanical strength of the intumescent layer and/or prevent their draining off. Examples of such additives are also found in U.S. Pat. No. 4,442,157 A, U.S. Pat. No. 3,562,197 A, GB 755 551 A and EP 138 546 A1.

Ash crust stabilizers, such as melamine phosphate or melamine borate, may also be included.

One or multiple reactive flame retardants may optionally also be added to the composition according to the present invention. Such compounds are incorporated in the binding agent. One example within the meaning of the invention are reactive organophosphorous compounds, such as 9,10-dihydro-9-oxa-10-phosphaphenanthrene-10-oxide (DOPO) and derivatives thereof, such as, for example, DOPO-HQ, DOPO-NQ, and adducts. Such compounds are described, for example, in S. V. Levchik, E. D. Weil, Polym. Int. 2004, 53, 1901-1929.

In addition to the insulating layer-forming additives, the composition may optionally also contain conventional auxiliary agents, such as solvents, for example, xylene or toluene, wetting agents based on polyacrylates and/or polyphosphates, defoamers, such as silicone defoamers, thickeners, such as alginate thickeners, dyes, fungicides, softeners, such as chlorinated waxes, binders, flame retardants or various fillers, such as vermiculite, inorganic fibers, quartz sand, micro glass beads, mica, silicon dioxide, mineral wool and the like.

Additional additives, such as thickeners, rheology additives and fillers may be added to the composition. Rheology additives used, such as anti-settling agents, anti-sag agents and thixotropic agents, are preferably polyhydroxy carbonic acid amides, urea derivatives, salts of unsaturated carbonic acid esters, alkyl ammonium salts of acidic phosphoric acid derivatives, ketoximes, amine salts of the p-toluene sulfonic acid, amine salts of sulfonic acid derivatives, as well as aqueous or organic solutions or mixtures of the compounds.

Rheology additives on the basis of pyrogenic or precipitated silicas or on the basis of silanized pyrogenic or precipitated silicas may also be used. The rheology additives are preferably pyrogenic silicates, modified and unmodified layer silicates, precipitated silicas, cellulose ethers, polysaccharides, PU and acrylate thickeners, urea derivatives, castor oil derivatives, polyamides, and fatty acid amides and polyolefins, if present in solid form, pulverized celluloses and/or suspension agents, such as, for example, xanthan gum.

The composition according to the present invention may be packaged as a two-component system or multicomponent system.

The component A and the component B may be stored together if they do not react to one another at room temperature without the use of an accelerator. In case a reaction at room temperature occurs, the component A and the component B must be situated separately from one another in a reaction-inhibiting manner. An accelerator, when present, must either be stored separately from the components A and B or the component that contains the accelerator must be stored separately from the other component. This ensures that the two components A and B of the binding agent are combined only just prior to application and trigger the hardening reaction. This makes the system easier to use.

In one preferred specific embodiment of the present invention, the composition according to the present invention is packaged as a two-component system, the component A and the component B being situated separately in a reaction-inhibiting manner. Accordingly, a first component, the component I, contains the component A and a second component, the component II, contains the component B. This ensures that the two components A and B of the binding agent are combined only just prior to application and trigger the hardening reaction. This makes the system easier to use.

In this case, the multifunctional Michael acceptor is preferably contained in the component I in an amount of 2% to 95% by weight.

The multifunctional Michael donor is contained in the component II preferably in an amount of 2% to 95% by weight, particularly preferably in an amount of 2% to 85% by weight.

The component C in this case may be contained in one component or in multiple components as a total mixture or divided into individual components. The division of the component C depends on the compatibility of the compounds contained in the composition, so that neither a reaction of the compounds with one another contained in the composition nor a reciprocal disruption may occur. This depends on the compounds used. This ensures that the highest possible proportion of fillers may be obtained. This results in a high intumescence in the same polymer matrix, even with a composition having low layer thicknesses.

The component C, the insulating layer-forming additive, may be contained in the composition in an amount of 30% to 99% by weight, the amount depending essentially on the mode of application of the composition (spraying, brushing and the like). To effect an advantageously high intumescence rate, the proportion of the component C in the overall formulation is set as high as possible. The proportion of the component C in the overall formulation is preferably 35% to 85% by weight, and particularly preferably 40% to 85% by weight.

The composition is applied as a paste with a brush, with a roller or by spraying it on the substrate, in particular metal substrate. The composition is preferably applied with the aid of an airless spray method.

Compared to the solvent-based systems and water-based systems, the composition according to the present invention is distinguished by a relatively rapid curing as a result of the addition reaction and, therefore, no necessary drying. This is very important, in particular when the coated components must be rapidly stressed or further processed, whether as a result of coating with a cover layer or of a movement or of transporting of the components. The coating is also significantly less susceptible to external influences at the construction site, such as, for example, impact from (rain)water or dust or dirt which, in the case of solvent-based systems or water-based systems, may result in a leaching out of water-soluble components, such as the ammonium polyphosphate or, in the case of dust accumulation, in a reduced intumescence. Because of its low viscosity, the composition remains simple to process, despite the high solid content, in particular using common spray methods. Due to the low softening point of the binding agent, and the high solid content, the expansion rate when exposed to heat is high, even in the case of low layer thickness.

For this reason, the composition according to the present invention is suitable as a coating, in particular as a fire protection coating, preferably sprayable coating for metallic and non-metallic-based substrates. The substrates are not limited and include components, in particular steel components and wooden components, but also single cables, cable bundles, cable lines and cable conduits or other lines.

The composition according to the present invention is used primarily in the construction sector as a coating, in particular as a fire protection coating for steel construction elements, but also for construction elements made of other materials, such as concrete or wood, as well as a fire protection coating for single cables, cable bundles, cable lines and cable conduits or other lines.

Thus, a further subject matter of the present invention is the use of the composition according to the present invention as a coating, in particular as a coating for construction elements or structural elements made of steel, concrete, wood and other materials, such as plastics, in particular as a fire protection coating.

The present invention also relates to objects obtained when the composition according to the present invention has cured. The objects have excellent insulation layer-forming properties.

The following examples serve to further explain the present invention.

### EXEMPLARY EMBODIMENTS

The following components are used for preparing insulating layer-forming compositions according to the present invention:

As indicated below, the individual components are mixed together to form two components I and II, the individual components being blended with the aid of a dissolver and homogenized. For the application, these mixtures are then mixed together and applied either before spraying or preferably during the spraying.

The curing behavior was observed in each case, the intumescence factor and the relative ash crust stability being subsequently determined. For this purpose, the mixtures were each placed in a round Teflon mold having a depth of approximately 2 mm and a diameter of 48 mm.

The time of curing in this case corresponds to the time after which the samples were fully hardened and could be removed from the Teflon mold.

To determine the intumescence factor and the relative ash crust stability, a muffle kiln was preheated to 600° C. A multiple measurement of the sample thickness was carried out with the caliper and the mean value h_{M} was calculated. Each of the samples was then introduced into a cylindrical steel mold and heated in the muffle kiln for 30 min. After cooling to room temperature, the foam height h_{E1} was first non-destructively determined (mean value of a multiple measurement). The intumescence factor I is calculated as follows:

I=h_{E1}:h_{M} Intumescence factor I:

Subsequently, a defined weight (m=105 g) was dropped from a defined height (h=100 mm) onto the foam in the cylindrical steel mold and the residual foam height h_{E2} after this partially destructive impact was determined. The relative ash crust stability was calculated as follows:

AKS=h_{E2}:h_{E1} relative ash crust stability (AKS):

In addition, the shrinkage during “drying”, i.e., the reaction of the two components, was measured.

For this purpose, a mold having a thickness of 10 mm was filled with each mixture. After curing, the molded bodies formed were removed from the mold and the thickness measured. The shrinkage is the product of the difference.

### Example 1

### Component A

| Component | Amount [g] |
|---|---|
| 1,1,1-tris(hydroxymethyl)propane triacrylate | 72.6 |

### Component B

| Component | Amount [g] |
|---|---|
| Thiocure ® GDMP¹ | 87.4 |

¹Glycol-di(3-mercaptopropionate)

### Component C

| Component | Amount [g] |
|---|---|
| Pentaerythrite | 50.0 |
| Melamine | 50.0 |
| Ammonium polyphosphate | 94.0 |
| Titanium dioxide | 46.0 |

To prepare a two-component system, the component C was divided in equal parts among the components A and B.

### Example 2

### Component A

| Component | Amount [g] |
|---|---|
| Pentaerythritol triacrylate | 72.8 |

### Component B

| Component | Amount [g] |
|---|---|
| Thiocure ® GDMP | 87.2 |

### Component C

| Component | Amount [g] |
|---|---|
| Pentaerythritol | 49.9 |
| Melamine | 49.8 |
| Ammonium polyphosphate | 95.1 |
| Titanium dioxide | 45.8 |

To prepare a two-component system, the component C was divided in approximately equal parts between the components A and B.

### Example 3

### Component A

| Component | Amount [g] |
|---|---|
| Pentaerythritol triacrylate | 9.0 |

### Component B

| Component | Amount [g] |
|---|---|
| Thiocure ® PETMP² | 11.0 |

²Pentaerythritol-tetra(3-mercaptopropionate)

### Component C

| Component | Amount [g] |
|---|---|
| Pentaerythritol | 6.2 |
| Melamine | 6.2 |
| Ammonium polyphosphate | 11.9 |
| Titanium dioxide | 5.7 |

To prepare a two-component system, the component C was mixed completely with component A.

The shrinkage in the case of all three compositions was less than 5.0%

### Comparison Example 1

A commercial fire protection product (Hilti CFP S-WB) based on aqueous dispersion technology was used as a comparison.

### Comparison Example 2

As an additional comparison, a standard epoxy amine system was used (Jeffamin® T-403, liquid, solvent-free and crystallization-resistant epoxy resin, made up of low molecular bisphenol A and bisphenol F-based epoxy resins (Epilox® AF 18-30, Leuna-Harze GmbH) and 1,6 hexanediol diglycidylether) which was tested, filled to 60% with an intumescent mixture similar to the examples above.

### Comparison Example 3

As an additional comparison, a standard epoxy amine system was used (isophorone diamine, trimethylol propane triacrylate and liquid, solvent-free and crystallization-resistant epoxy resin, made up of low molecular bisphenol A and bisphenol F-based epoxy resin (Epilox® AF 18-30, Leuna-Harze GmbH)), which was tested, filled to 60% with an intumescent mixture similar to the examples above.

TABLE 1
Measurement results of the intumescence factor,
the ash crust stability and the curing time

| | | Relative | | | |
|---|---|---|---|---|---|
| | Intumescence | ash crust | Sample | | |
| | factor I | stability AKS | thickness h_{M} | Curing | |
| Example | (multiple) | (multiple) | (mm) | time | |
| 1 | 9.72 | 0.79 | 3.09 | 2 | hours |
| 2 | 14.5 | 0.77 | 2.65 | 4 | hours |
| 3 | 10.7 | 0.52 | 2.64 | 6 | hours |
| Comparison | 36 | 0.62 | 1.8 | 10 | days |
| example 1 | | | | | |
| Comparison | 22 | 0.04 | 1.6 | 12 | hours |
| example 2 | | | | | |
| Comparison | 1.7 | 0.6 | 1.2 | 1 | day |
| example 3 | | | | | |

1-23. (canceled)

24: An insulating layer-forming composition comprising:
a component A containing a multifunctional Michael acceptor having at least two electron-deficient carbon multiple bonds per molecule as a functional Michael acceptor group;
a component B containing a multifunctional Michael donor having at least two thiol groups per molecule as a functional Michael donor group; and
a component C containing an insulating layer-forming additive.

25: The composition as recited in claim 24 wherein the functional Michael acceptor group has the structure (XX): 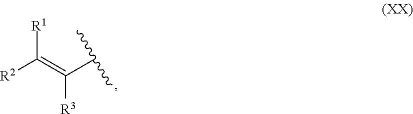
in which
R₁, R₂ and R₃ each represent, independently of one another, hydrogen, a linear, branched or cyclical, optionally, substituted alkyl group, aryl group, aralkyl group or alkylaryl group, whereby these may also contain, independently of one another, additional ether groups, carboxyl groups, carbonyl groups, thiol-analog groups, nitrogen-containing groups or combinations thereof.

26: The composition as recited in claim 25 wherein each functional Michael acceptor group is directly deposited on a skeleton, either directly or via a linker.

27: The composition as recited in claim 26 wherein the skeleton is a monomer, an oligomer or a polymer.

28: The composition as recited in claim 27 wherein the skeleton is a polyol compound, which is selected from the group consisting of alkanediols, alkylene glycols, glycerin, 2-(hydroxymethyl)propane-1,3-diol, 1,1,1,-tris(hydroxymethyl)ethane, 1,1,1-trimethylolpropane, di(trimethylolpropane), tricyclodecane dimethylol, 2,2,4-trimethyl-1,3-pentanediol, bisphenol A, cyclohexane dimethanol, alkoxylated and/or ethoxylated and/or propoxylated derivatives of neopentyl glycol, tertraethylene glycol cyclohexanedimethanol, hexanediol, 2-(hydroxymethyl)propane-1,3-diol, 1,1,1-tris(hydroxymethyl)ethane, 1,1,1-trimethylolpropane and castor oil, pentaerythritol, sugar, polyvalent derivatives thereof or mixtures thereof.

29: The composition as recited in claim 24 wherein the multifunctional Michael donor has at least three thiol groups per molecule.

30: The composition as recited in claim 24 wherein the multifunctional Michael donor is selected from the group consisting of glycol-bis(2-mercaptoacetate), glycol-bis(3-mercaptopropionate), 1,2-propylene glycol-bis(2-mercaptoacetate), 1,2-propylene glycol-bis(3-mercaptopropionate), 1,3-propylene glycol-bis(2-mercaptoacetate), 1,3-propylene glycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylolpropane-tris(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptobutyrate), Capcure 3-800 (BASF), GPM-800 (Gabriel Performance Products), Capcure LOF (BASF), GPM-800LO (Gabriel Performance Products), KarenzMT PE-1 (Showa Denko), 2-ethylhexylthioglycolate, iso-octylthioglycolate, di(n-butyl)thiodiglycolate, glycol-di-3-mercaptopropionate, 1,6-hexanedithiol, ethylene glycol-bis(2-mercaptoacetate) and tetra(ethylene glycol)dithiol.

31: The composition as recited in claim 24 wherein the reactive equivalent ratio is in the range of 0.1:1 to 10:1.

32: The composition as recited in claim 24 wherein the component A or the component B also contains a catalyst for the Michael addition reaction.

33: The composition as recited in claim 24 wherein the insulating layer-forming additive includes a mixture, or includes at least one thermally expandable compound.

34: The composition as recited in claim 33 wherein the mixture includes at least one carbon source, at least one dehydrogenation catalyst.

35: The composition as recited in claim 33 wherein the insulating layer-forming additive also contains an ash crust stabilizer.

35: The composition as recited in claim 24 further comprising organic or inorganic aggregates or other additives.

36: A packaged two-component system or a multi-component system comprising the composition as recited in claim 24.

37: The packaged two-component system as recited in claim 36 wherein component A and the component B are divided between two components, component I and component II, in a reaction-inhibiting manner.

38: The packaged two-component system as recited in claim 37 wherein the multifunctional Michael acceptor is contained in the component I in an amount of 2% to 95% by weight.

39: The packaged two-component system as recited in claim 37 wherein the multifunctional Michael donor is contained in the component II in an amount of 2% to 95% by weight.

40: The packaged two-component system as recited in claim 37 wherein the component C is divided between the component I and the component II in such a way that compounds are separated from one another in a reaction-inhibiting manner.

41: The packaged two-component system as recited in claim 40 wherein component C includes at least one carbon source, at least one propellant and at least one dehydrogenation catalyst

42: The packaged two-component system as recited in claim 41 wherein the component C also contains an ash crust stabilizer divided between the component I and the component II in such a way that the component I or the component II contains at least a portion of the ash crust stabilizer.

43: The packaged two-component system as recited in claim 42 wherein the other of the component II or the component I contains another portion of the ash crust stabilizer.

44: A method comprising:
applying the composition as recited in claim 24 as a coating.

45: The method as recited in claim 44 wherein the coating coats steel construction elements.

46: The method as recited in claim 44 wherein the coating coats metallic or non-metallic substrates.

47: The method as recited in claim 44 wherein the coating is a fire protection layer.

48: A hardened object, obtained by hardening the composition as recited in claim 24.
